(19) United States
(12) Patent Application Publication
(10) Pub. No.: US 2025/0245613 A1
(43) Pub. Date: Jul. 31, 2025

(54) SYSTEM

(71) Applicant: TOYOTA JIDOSHA KABUSHIKI KAISHA, Toyota-shi (JP)

(72) Inventors: Hirohiko TANIGUCHI, Yokohama-shi (JP); Hiroto TOMIDA, Tokyo (JP); Yusuke SUGIHARA, Tokyo (JP); Ai FUJIMURA, Osaka (JP); Yasuhiro HARA, Nagoya-shi (JP); Taito SASAKI, Nagakute-shi (JP); Fujimi SASAHARA, Nagoya-shi (JP); Yasuhiro KOBATAKE, Nagoya-shi (JP)

(73) Assignee: TOYOTA JIDOSHA KABUSHIKI KAISHA, Toyota-shi (JP)

(21) Appl. No.: 18/916,755

(22) Filed: Oct. 16, 2024

(30) Foreign Application Priority Data
Jan. 25, 2024 (JP) 2024-009743

(51) Int. Cl. G06Q 10/0835; G06Q 10/0639; G06Q 10/0833

(52) U.S. Cl. CPC G06Q 10/08355; G06Q 10/06393; G06Q 10/0833

(57) ABSTRACT

A system for scoring an operation of a delivery person who delivers a delivery item includes an information processing device and a terminal device associated with a vehicle operated by the delivery person or the delivery person. The terminal device transmits route information of the vehicle to the information processing device. Next, the information processing device performs scoring on the driving of the delivery person and the route information of the vehicle on the basis of the delivery result information of the delivery object. Then, the information processing device determines route information to be presented to the other delivery person based on the driving of the delivery person or the score of the route information of the vehicle.

### CROSS-REFERENCE TO RELATED APPLICATION

This application claims priority to Japanese Patent Application No. 2024-009743 filed on Jan. 25, 2024, incorporated herein by reference in its entirety.

### BACKGROUND

### 1. Technical Field

The present disclosure relates to a system.

### 2. Description of Related Art

Hitherto, technologies for improving the quality of delivery are known. For example, Japanese Unexamined Patent Application Publication No. 2021-174292 (JP 2021-174292 A) discloses a technology for improving efficiency by creating a delivery route that combines truck transportation and motorcycle transportation.

### SUMMARY

Improvements are desired in the technologies for improving the quality of delivery.

In view of such circumstances, the present disclosure can improve the technologies for improving the quality of delivery.

A system according to one embodiment of the present disclosure is a system configured to score driving of a delivery person who delivers a delivery item. The system includes:
an information processing device; and
a terminal device associated with the delivery person or a vehicle to be driven by the delivery person.
   The terminal device is configured to transmit route information of the vehicle to the information processing device.
   The information processing device is configured to score the driving of the delivery person and the route information of the vehicle based on delivery result information on the delivery item.
   The information processing device is configured to determine route information to be presented to another delivery person based on a score of the delivery person or the route information.

According to the embodiment of the present disclosure, the technologies for improving the quality of delivery are improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a schematic configuration of a system according to an embodiment of the present disclosure;

FIG. 2 is a block diagram illustrating a schematic configuration of a terminal device;

FIG. 3 is a diagram illustrating a schematic configuration of an information processing device; and

FIG. 4 is a sequence diagram illustrating the operation of the system.

### DETAILED DESCRIPTION OF EMBODIMENTS

Hereinafter, an embodiment of the present disclosure will be described.

### Outline of Embodiment

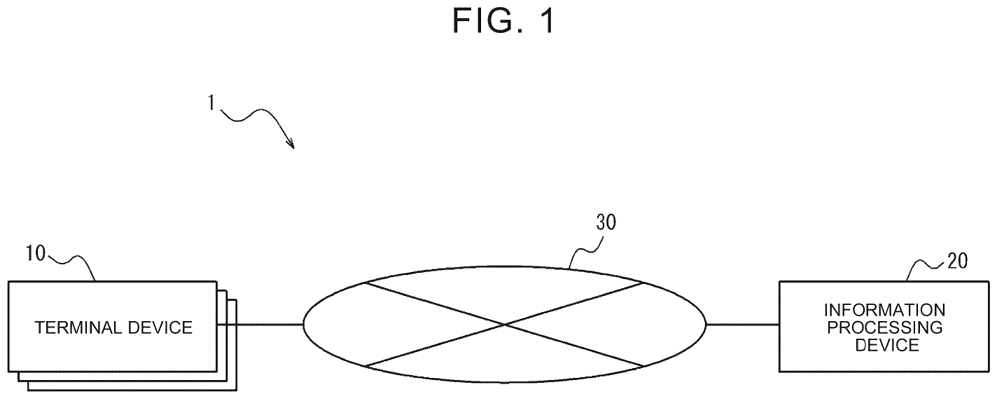

The outline of a system 1 according to an embodiment of the present disclosure will be described with reference to FIG. 1. The system 1 includes a plurality of terminal devices 10 and an information processing device 20. Each of the terminal devices 10 and the information processing device 20 is communicably connected to a network 30 including, for example, the Internet and a mobile communication network.

The terminal device 10 is, for example, a PC (Personal Computer), a smart phone, or a computer such as a tablet terminal. In the present embodiment, the terminal device 10 is used by a delivery person who delivers a delivery item. The terminal device 10 may be a computer mounted on a vehicle.

The information processing device 20 is, for example, a computer such as a server apparatus. The information processing device 20 is capable of communicating with a plurality of terminal devices 10 via the network 30.

First, the outline of the present embodiment will be described, and the details will be described later. A system 1 that performs scoring for an operation of a delivery person who delivers a delivery item includes an information processing device 20 and a terminal device 10 associated with a vehicle operated by the delivery person or the delivery person. The terminal device 10 transmits route information of the vehicle to the information processing device 20. Next, the information processing device 20 performs scoring on the driving of the delivery person and the route information of the vehicle on the basis of the delivery result information of the delivery object. Then, the information processing device 20 determines the route information to be presented to the other delivery person based on the driving of the delivery person or the score of the route information of the vehicle.

In general, by using a route with less vibration during traveling, the probability that damage or the like will occur in the delivered article is reduced. Also, delivery personnel with high scores may empirically employ routes with less vibration during travel. According to the present embodiment, the information processing device 20 determines route information to be presented to another deliverer based on the driver's driving or the score of the route information of the vehicle. Thus, for example, route information used by a delivery person having a high score for driving can be presented to another delivery person, or route information different from route information used by a delivery person having a low score can be presented to another delivery person. Therefore, by using the route indicated by the route information presented by the other delivery person, the probability that damage or the like will occur in the delivery object during the delivery can be reduced. Therefore, according to the present embodiment, a technique for improving the quality of delivery is improved in that the probability of occurrence of damage or the like in the delivery object during delivery can be reduced.

Next, each configuration of the system 1 will be described in detail.

### Configuration of Terminal Device

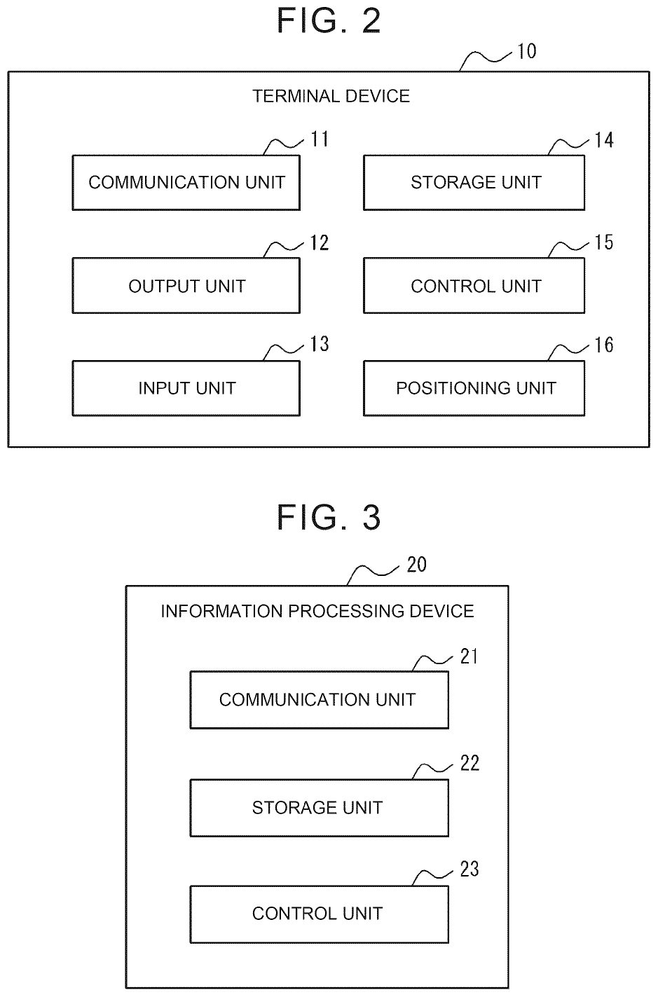

As illustrated in FIG. 2, the terminal device 10 includes a communication unit 11, an output unit 12, an input unit 13, a storage unit 14, a control unit 15, and a positioning unit 16.

The communication unit 11 includes one or more communication interfaces connected to the network 30. The communication interfaces correspond to mobile communication standards such as 4G (4th Generation) or 5G (5th Generation), but are not limited thereto. In the present embodiment, the terminal device 10 communicates with the information processing device 20 via the communication unit 11 and the network 30.

The output unit 12 includes one or more output devices for outputting information. For example, the output devices are, but are not limited to, a display that outputs information as images, a speaker that outputs information as audio, and the like. Alternatively, the output unit 12 may include an interface for connecting an external output device.

The input unit 13 includes one or more input devices that detect an input operation by a user. The input device is, for example, a physical key, a capacitive key, a mouse, a touch panel, a touch screen integrally provided with a display of the output unit 12, a microphone, or the like, but is not limited thereto. Alternatively, the input unit 13 may include an interface for connecting an external input device.

The storage unit 14 includes one or more memories. The memories are, for example, a semiconductor memory, a magnetic memory, or an optical memory, but are not limited to these memories. Each memory included in the storage unit 14 may function as, for example, a main storage device, an auxiliary storage device, or a cache memory. The storage unit 14 stores any information used for the operation of the terminal device 10. The storage unit 14 may store route information of the vehicle associated with the terminal device 10. Further, for example, the storage unit 14 may store a system program, an application program, embedded software, and the like. For example, the information stored in the storage unit 14 may be updatable by, for example, information acquired from the network 30 via the communication unit 11.

The control unit 15 includes one or more processors, one or more programmable circuits, one or more dedicated circuits, or a combination of these. The processors are, for example, a general-purpose processor such as a central processing unit (CPU) or a graphics processing unit (GPU), or a dedicated processor specialized for a specific process, but are not limited to these processors. The programmable circuits are, for example, a field-programmable gate array (FPGA), but are not limited to the circuit. The dedicated circuits are, for example, an application specific integrated circuit (ASIC), but are not limited to the circuit. The control unit 15 controls the operation of the terminal device 10. The control unit 15 may control the operation of the vehicle associated with the terminal device 10.

The positioning unit 16 includes one or more devices that acquire position information of the terminal device 10. Specifically, the positioning unit 16 is, for example, a position sensor corresponding to GPS (Global Positioning System) or the like, a geomagnetic sensor, a speed sensor, an acceleration sensor, or a gyro sensor or the like. However, the present disclosure is not limited thereto, and the positioning unit 16 may be an arbitrary sensor.

### Configuration of Information Processing Device

As shown in FIG. 3, the information processing device 20 includes a communication unit 21, a storage unit 22, and a control unit 23.

The communication unit 21 includes one or more communication interfaces connected to the network 30. The communication interfaces support, for example, a mobile communication standard, a wired local area network (LAN) standard, or a wireless LAN standard, but the supported standards are not limited to these, and the communication interfaces may support any communication standard. In the present embodiment, the information processing device 20 communicates with the plurality of terminal devices 10 via the communication unit 21 and the network 30.

The storage unit 22 includes one or more memories. Each memory included in the storage unit 22 may function as, for example, a main storage device, an auxiliary storage device, or a cache memory. The storage unit 22 stores any information used for the operation of the information processing device 20. For example, the storage unit 22 may store a system program, an application program, embedded software, a database, and the like. In the present embodiment, the storage unit 22 stores route information of a plurality of vehicles associated with a plurality of terminal devices 10 connected to the information processing device 20 via the network 30. Further, the storage unit 22 stores delivery information of each delivery item, such as delivery place information of the delivery item, vehicle information to be delivered, and delivery person information. The information stored in the storage unit 22 may be updatable with information received from the network 30 via the communication unit 21, for example.

The control unit 23 includes one or more processors, one or more programmable circuits, one or more dedicated circuits, or a combination of these. The processors are, for example, a general-purpose processor such as a central processing unit (CPU) or a graphics processing unit (GPU), or a dedicated processor specialized for a specific process, but are not limited to these processors. The programmable circuits are, for example, a field-programmable gate array (FPGA), but are not limited to the circuit. The dedicated circuits are, for example, an application specific integrated circuit (ASIC), but are not limited to the circuit. The control unit 23 controls the operation of the information processing device 20 as a whole.

### Operation Flow of the System 1

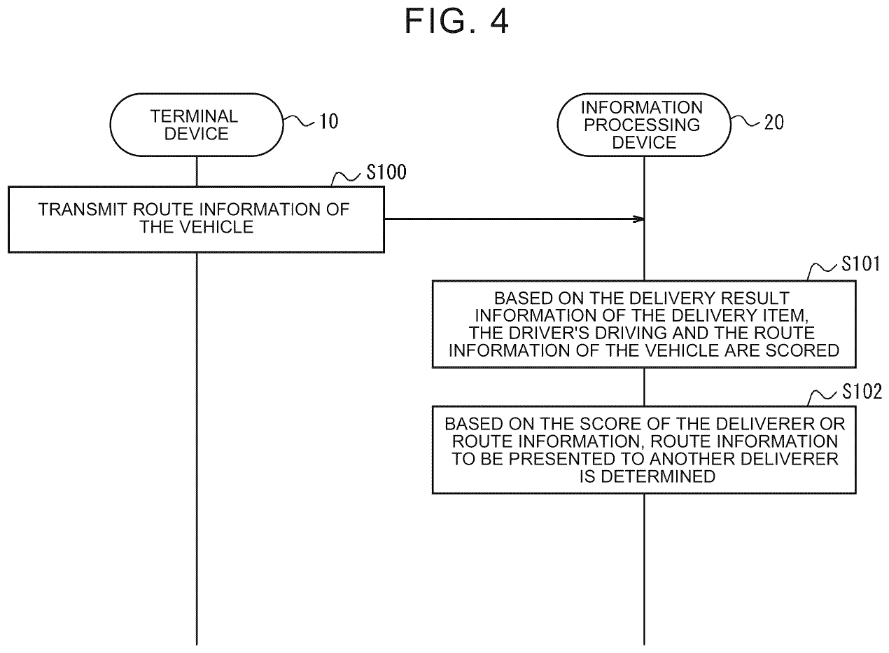

An operation of the terminal device 10 and the information processing device 20 in the system 1 according to the present embodiment will be described with reference to FIG. 4.

S100: The control unit 15 of the terminal device 10 transmits route information of vehicles associated with the terminal device 10 to the information processing device 20.

Specifically, the control unit 15 transmits route information of the vehicle used for the current delivery stored in the storage unit 14 to the information processing device 20 via the communication unit 11 after the delivery person delivers the delivery item. Next, the control unit 23 of the information processing device 20 stores the route information of the vehicle received via the communication unit 21 and the network 30 in the storage unit 22. Whether or not the delivery person has delivered the delivery product may be determined by inputting a delivery completion report performed by the delivery person using the input unit 13 of the terminal device 10, but the present disclosure is not limited thereto and can be performed by any method. Note that the control unit 15 may transmit the route information to the information processing device 20 at an arbitrary timing at which the route information is determined, instead of after the delivery of the delivery item.

The information processing device 20 may specify route information of the vehicle associated with the terminal device 10. Specifically, the control unit 15 periodically transmits the position information of the vehicle acquired by using the positioning unit 16 to the information processing device 20. Next, the control unit 23 of the information processing device 20 determines the route information of the vehicle by using the position information of the vehicle received from the terminal device 10 via the communication unit 11.

The “route information of the vehicle” is information indicating a route used by the delivery person when the delivery item is delivered using the vehicle. For example, the route information of the vehicle may be information that can be displayed on a map displayed on the display of the terminal device 10, but is not limited thereto.

S101: The control unit 23 of the information processing device 20 performs scoring on the driving of the delivery person and the route information of the vehicle based on the delivery outcome information of the delivery item.

For example, the “delivery result information of the delivery item” may include information on the presence or absence of a complaint from the recipient of the delivery item, information on the result of the questionnaire to the recipient of the delivery item, and information on the state of the delivery item at the time of delivery. Further, the “delivery result information of the delivery item” may include information on a time taken for delivery of the delivery item, information on a delivery time of the delivery item, and information on a driving state at the time of delivery of the vehicle. However, the “delivery result information of the delivery item” may include any information related to the delivery of the delivery item, which is not limited thereto.

The delivery status of the delivery item may include, for example, the presence or absence of loss of the delivery item, the presence or absence of damage to the delivery item, and/or the presence or absence of opening of the delivery item. Further, for example, in a case where the delivery item is a refrigerated and frozen item, the state at the time of delivery of the delivery item may include the presence or absence of dissolution of the delivery item.

For example, in a case where the delivery result information of the delivery object does not include the information of the damage of the delivery object, the control unit 23 may set a high score for the driving of the delivery person and the route information of the vehicle. For example, in a case where the delivery result information of the delivery object includes the information of the damage of the delivery object, the control unit 23 may set a low score for the driving of the delivery person and the route information of the vehicle.

For example, in a case where the delivery result information of the delivery object includes the information of the delivery time of the delivery object and the delivery time of the delivery object is within the scheduled delivery time, the control unit 23 may set a high score for the driving of the delivery person and the route information of the vehicle. For example, in a case where the delivery result information of the delivery object includes the information of the delivery time of the delivery object and the delivery time of the delivery object exceeds the scheduled delivery time, the control unit 23 may set a low score with respect to the driving of the delivery person and the route information of the vehicle.

The control unit 23 may score on the basis of the respective pieces of information included in the delivery result information of the delivery item, or may comprehensively score.

S102: The control unit 23 determines route information to be presented to another delivery person based on the driving of the delivery person or the scoring of the route information of the vehicle.

Specifically, when the score of the operation of the delivery person is larger than the first predetermined value, the control unit 23 may determine the route information used by the delivery person for delivery as the route information to be presented to the other delivery person. In addition, when the score of the route information of the vehicle is larger than the first predetermined value, the control unit 23 may determine the route information as route information to be presented to another delivery person.

The first defined value may be changeable.

Alternatively, in a case where the score of the operation of the delivery person is within the specified rank in the score of the delivery person stored in the storage unit 22, the control unit 15 may determine the route information used by the delivery person for delivery as the route information to be presented to the other delivery person. In addition, in a case where the score of the route information of the vehicle is within the specified order in the score of the route information of the vehicle stored in the storage unit 22, the control unit 23 may determine the route information as route information to be presented to another delivery person.

When a new delivery occurs, the control unit 23 may transmit route information to be presented to another delivery person to the terminal device 10 associated with the vehicle that performs the new delivery.

Specifically, when a new delivery occurs, the control unit 23 determines whether or not the route information to be presented to another delivery person stored in the storage unit 22 can be used for the new delivery, based on the delivery place information of the new delivery stored in the storage unit 22. When it is determined that the vehicle can be used, the control unit 23 transmits route information to be presented to the other delivery person to the terminal device 10 associated with the vehicle that performs the new delivery. Note that the number of pieces of route information to be presented to other delivery personnel to be transmitted to the terminal device 10 may be plural.

As described above, the system 1 for scoring the operation of the delivery person who delivers the delivery item includes the information processing device 20 and the terminal device 10 associated with the vehicle operated by the delivery person or the delivery person. The terminal device 10 transmits route information of the vehicle to the information processing device 20. Next, the information processing device 20 performs scoring on the driving of the delivery person and the route information of the vehicle on the basis of the delivery result information of the delivery object. Then, the information processing device 20 determines the route information to be presented to the other delivery person based on the driving of the delivery person or the score of the route information of the vehicle.

In general, by using a route with less vibration during traveling, the probability that damage or the like will occur in the delivered article is reduced. Also, delivery personnel with high scores may empirically employ routes with less vibration during travel. According to such a configuration, the information processing device 20 determines the route information to be presented to the other deliverer based on the driver's driving or the score of the route information of the vehicle. Thus, for example, route information used by a delivery person having a high score for driving can be presented to another delivery person, or route information different from route information used by a delivery person having a low score can be presented to another delivery person. Therefore, by using the route indicated by the route information presented by the other delivery person, the probability that damage or the like will occur in the delivery object during the delivery can be reduced. Therefore, according to the present embodiment, a technique for improving the quality of delivery is improved in that the probability of occurrence of damage or the like in the delivery object during delivery can be reduced.

Although the present disclosure has been described above based on the drawings and the embodiment, it should be noted that those skilled in the art may make various modifications and alterations thereto based on the present disclosure. It should be noted, therefore, that these modifications and alterations are within the scope of the present disclosure. For example, the functions included in the configurations, steps, etc. can be rearranged so as not to be logically inconsistent, and a plurality of configurations, steps, etc. can be combined into one or divided.

For example, in the above-described embodiment, the configuration and operation of the terminal device 10 and/or the information processing device 20 may be distributed among a plurality of computers capable of communicating with each other. Further, for example, an embodiment in which some or all of the components of the information processing device 20 are provided in the terminal device 10 is also possible, and conversely, an embodiment in which some or all of the components of the terminal device 10 are provided in the information processing device 20 is also possible. For example, the terminal device 10 may include some or all of the constituent elements of the information processing device 20, and the information processing device 20 may include some or all of the constituent elements of the terminal device 10. In addition, for example, the system 1 according to the above-described embodiment may be used to provide MaaS (Mobility as a Service), which is a service that utilizes mobility.

Further, for example, in the above-described embodiment, the control unit 23 may further determine route information not to be used by another deliverer based on the driving of the deliverer or the score of the route information of the vehicle.

Specifically, when the score of the operation of the delivery person is smaller than the second predetermined value, the control unit 23 may determine the route information used by the delivery person for delivery as the route information to be presented to the other delivery person. In addition, when the score of the route information of the vehicle is smaller than the second predetermined value, the control unit 23 may determine the route information as route information to be presented to another delivery person.

The second defined value may be changeable.

Alternatively, when the score of the operation of the delivery person is equal to or lower than the specified order in the score of the delivery person stored in the storage unit 22, the control unit 15 may determine the route information used by the delivery person for delivery as the route information to be presented to the other delivery person. In addition, when the score of the route information of the vehicle is equal to or lower than the specified order in the score of the route information of the vehicle stored in the storage unit 22, the control unit 23 may determine the route information as the route information to be presented to another delivery person.

When a new delivery occurs, the control unit 23 may transmit route information that is not used by another deliverer to the terminal device 10 associated with the vehicle that performs the new delivery.

Specifically, when a new delivery occurs, the control unit 23 determines whether or not route information stored in the storage unit 22 that is not to be used by another delivery person can be used for the new delivery, based on the delivery point information of the new delivery stored in the storage unit 22. When it is determined that it can be used, the control unit 23 transmits route information that is not used by the other delivery person to the terminal device 10 associated with the vehicle that performs the new delivery. The control unit 15 of the terminal device 10 outputs the route information not to be used in such a manner that the delivery person can understand that the route information not to be used cannot be used on the display of the terminal device 10.

The “understandable mode” may be, for example, a route that is not used by other delivery personnel on a map displayed on the display of the terminal device 10 may be displayed by a dotted line in gray, but any mode that is not limited thereto may be adopted.

Alternatively, when a new delivery occurs, the control unit 23 may exclude the route information that is not used by another deliverer from the route information that is transmitted to the terminal device 10 associated with the vehicle that performs the new delivery.

As described above, the route information used by the delivery person having a low score for driving or the route information having a low score is not used by the other delivery person, so that the probability of occurrence of damage or the like in the delivery object during delivery may be low.

Further, for example, in the above-described embodiment, the control unit 23 of the information processing device 20 may determine the route information to be presented to another delivery person based on the road information on the route of the vehicle.

The “road information” is any information capable of grasping the state of a road. For example, the road information may include any one or more of a state of the road, a traffic volume of the road, weather information, and vehicle regulations. However, the present disclosure is not limited thereto, and may include any information capable of grasping the situation of the road. The condition of the road is, for example, usually during paving work. The traffic volume of the road is, for example, whether or not a traffic jam has occurred.

The road information may be acquired from, for example, a surveillance camera installed in the vicinity of the road, or may be acquired from the storage unit 22 of the information processing device 20. Further, the road information may be acquired from another information processing device capable of communicating with the information processing device 20 (for example, a server of a road traffic information center). Alternatively, it may be a combination thereof.

In the above-described modification, for example, a case where a traffic jam occurs on a road on a route presented to the other delivery person will be considered. In this case, when the control unit 23 determines in S102 whether or not the route information to be presented to the other delivery person can be used for the new delivery, the control unit 23 may determine that the route information to be presented to the other delivery person cannot be used. For example, when the condition of the road on the route to be presented to the other delivery person is normal and no congestion has occurred, the control unit 23 may determine that the route information to be presented to the other delivery person can be used.

Further, for example, in the above-described embodiment, the control unit 23 of the information processing device 20 may determine the route information to be presented to the other delivery person based on the type of the vehicle.

The “type of vehicle” is, for example, a normal vehicle, a motorcycle, a bus, or a truck, but may include specific information such that the number of wheels of the vehicle, the height of the vehicle, and the like are known.

In the above-described modification, for example, a case is considered in which there is a vehicle restriction of only a motorcycle on a road on a route presented to the other delivery person, and a vehicle used by the other delivery person is a normal vehicle. In this case, when the control unit 23 determines in S102 whether or not the route information to be presented to the other delivery person can be used for the new delivery, the control unit 23 may determine that the route information to be presented to the other delivery person cannot be used. For example, in a case where there is a vehicle restriction of only a motorcycle on a road on a route to be presented to the other delivery person and the vehicle used by the other delivery person is a motorcycle, the control unit 23 may determine that the route information to be presented to the other delivery person can be used.

Further, for example, in the above-described embodiment, the control unit 23 of the information processing device 20 may give an incentive to the delivery person based on the score of the delivery person.

Specifically, when the score of the delivery person scored in S101 is larger than the third predetermined value, the control unit 23 decides to give the delivery person an incentive.

The incentive may be, for example, the payment of a bonus to the deliverer or an increase in the salary of the deliverer, but may be any incentive without limitation.

Thus, by providing incentives to the deliverer, the deliverer will aim for a high score. Therefore, since the delivery person uses a route having a high score transmitted from the information processing device 20, there is a low probability that the delivery object is damaged or the like during delivery.

The third defined value may be changeable.

In addition, in the above-described embodiment, the system 1 may include a vibration detection device attached to a delivery item or a package storage device. Further, the vibration detection device may transmit information related to the vibration detected during delivery of the delivery object to the information processing device 20. The control unit 23 of the information processing device 20 may perform scoring on the driving of the delivery person and the route information of the vehicle based on the information related to the vibration.

Specifically, the vibration detection device attached to the delivery item or the package storage device repeatedly acquires information related to the vibration of the vehicle or the delivery item at the time of delivery at predetermined time intervals, and transmits the information related to the vibration to the information processing device 20 via the network 30. The control unit 23 sets a higher score for the driving of the delivery person and the route information of the vehicle as the vibration value included in the information related to the vibration received via the communication unit 21 is smaller. The control unit 23 sets a lower score with respect to the driving of the delivery person and the route information of the vehicle as the vibration value included in the information related to the vibration received via the communication unit 21 increases.

The vibration detection device is a device for detecting vibration in an object or an environment and acquiring information on the vibration. The vibration detection device is, for example, an acceleration sensor, a vibration sensor, a piezoelectric element, or the like, but is not limited thereto, and may be any sensor.

“Vibration” can be represented by physical quantities such as displacement, velocity, acceleration, etc. Further, the above-described “vibration value” that can be included in “information related to vibration” is, for example, an execution value, a vibration level, or the like, but is not limited thereto, and may be an arbitrary index value indicating the magnitude of vibration.

The “predetermined time interval” can be any time interval including 1 second, 2 seconds, 5 seconds, 10 seconds, 1 minute, 2 minutes, 10 minutes, 30 minutes, and 1 hour. Further, the predetermined time interval may be changed as appropriate.}

Alternatively, the vibration detection device may acquire information related to vibration in real time.

Further, for example, a general-purpose computer may function as the terminal device 10 or the information processing device 20 according to the above-described embodiment. Specifically, a program describing each function of the terminal device 10 or each function of the information processing device 20 according to the above-described embodiment is stored in a memory of a general-purpose computer, and the program is read and executed by a processor. Therefore, the present disclosure can also be realized as a program that can be executed by the processor or a non-transitory computer-readable medium that stores the program.

What is claimed is:

1. A system configured to score driving of a delivery person who delivers a delivery item, the system comprising:
an information processing device; and
a terminal device associated with the delivery person or a vehicle to be driven by the delivery person, wherein
the terminal device is configured to transmit route information of the vehicle to the information processing device,
the information processing device is configured to score the driving of the delivery person and the route information of the vehicle based on delivery result information on the delivery item, and
the information processing device is configured to determine route information to be presented to another delivery person based on a score of the delivery person or the route information.

2. The system according to claim 1, wherein the information processing device is configured to determine the route information to be presented to the other delivery person based further on road information on a route of the vehicle.

3. The system according to claim 1, wherein the information processing device is configured to determine the route information to be presented to the other delivery person based further on a type of the vehicle.

4. The system according to claim 1, wherein the information processing device is configured to provide an incentive to the delivery person based on the score of the delivery person.

5. The system according to claim 1, wherein:
the system includes a vibration detection device attached to the delivery item or a luggage storage device;
the vibration detection device is configured to transmit, to the information processing device, information on vibration detected during delivery of the delivery item; and
the information processing device is configured to score the driving of the delivery person and the route information of the vehicle based further on the information on the vibration.

6. A method for providing mobility as a service using the system according to claim 1.
